(19) United States
(12) Patent Application Publication
(10) Pub. No.: US 2008/0025153 A1
(43) Pub. Date: Jan. 31, 2008

(54) Clock watch

(76) Inventor: Henry Tobias Gillespie, Derby (GB)

Correspondence Address: HENRY TOBIAS GILLESPIE, 9 ADLER COURT, DERBY, DE13QL, omitted

(21) Appl. No.: 11/529,752

(22) Filed: Nov. 23, 2004

(30) Foreign Application Priority Data
Jun. 29, 2004 (GB) 3017856

(51) Int. Cl. G04C 19/00

(52) U.S. Cl. 368/82

(57) ABSTRACT

The new clock-watch is both a new display system and a new electric time keeping system, a digital quarts time keeping system keeps the time and the rest of the digital system switches on and off the units that display the time, the display consists of four vertical rows of ten units, each of the four vertical rows of ten units individually represents a number according to how many of the units are displayed, so when you count the units that are displaying in each of the four individual vertical rows of ten units, from left to right, the four numbers give you the time.

### CROSS-REFERENCE TO RELATED APPLICATIONS

Not applicable.

### STATEMENT REGARDING FEDERALLY SPONSORED RESEARCH OR DEVELOPMENT.

Not applicable.

### REFERENCE TO SEQUENCE LISTING, A TABLE, OR A COMPUTER PROGRAM LISTING COMPACT DISC APPENDIX.

Not applicable.

### BACKGROUND OF THE INVENTION

The subject matter of the claimed invention is a new digital time keeping system and its electrical time display system, a new type of clock or watch.

### BRIEF SUMMARY OF THE INVENTION

The general idea of the claimed invention is a new clock or watch that displays the time in four vertical rows of ten units, each of the four vertical rows of ten units individually represents a number according to how many of the units are showing, so when you count the units that are showing in each vertical row from left to right the four numbers give you the time.

### BRIEF DESCRIPTION OF THE SEVERAL VIEWS OF THE DRAWINGS

FIG. 1/7 depicts the invention using an L,C,D, (LIQED CRISTAL DISPLY) system to display the time as a clock.

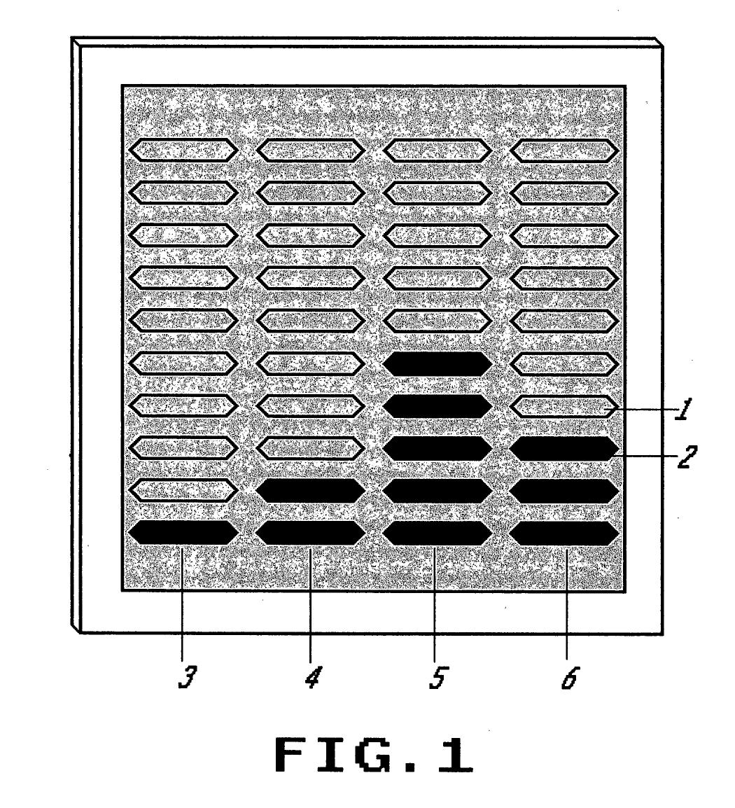

FIG. 2/7 depicts the invention using round L,E,D,S (LIGHT EMMITING DIODS) to display the time as a clock.

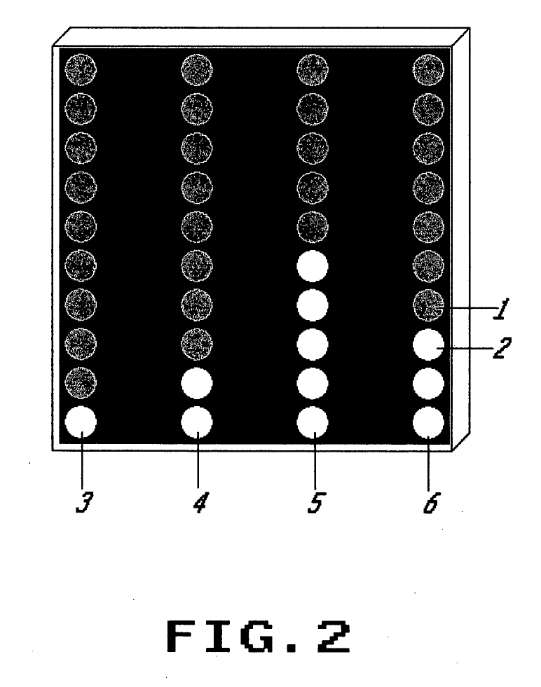

FIG. 3/7 depicts the invention using rectangle L,E,D,S (LIGHT EMMITING DIODS) to display the time as a clock.

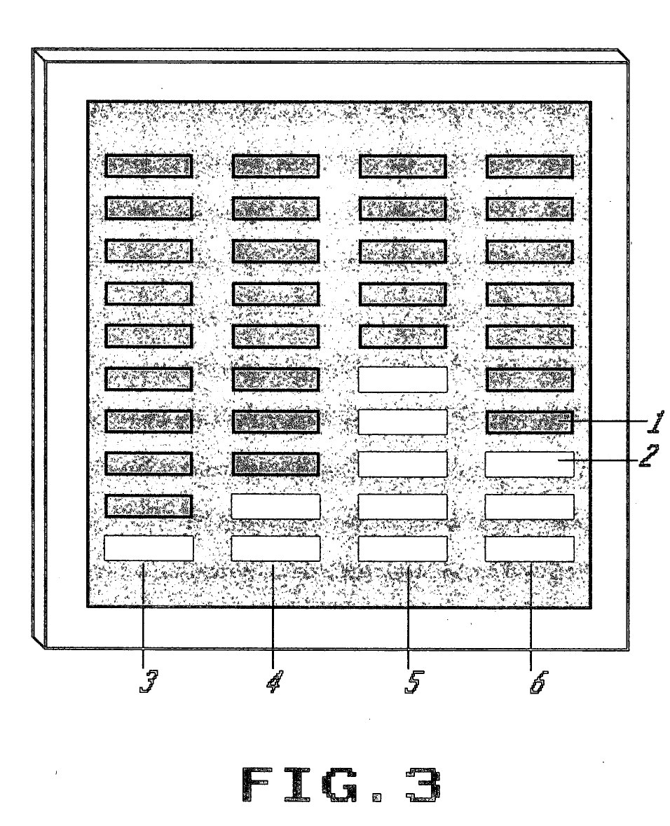

FIG. 4/7 depicts the invention using an L,C,D, (LIQED CHRISTAL DISPLAY) to display the time as a watch.

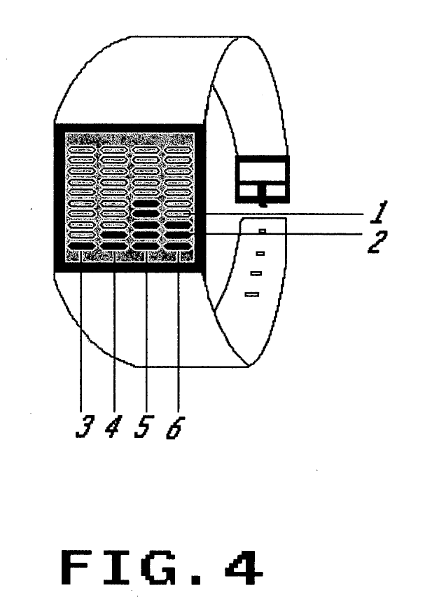

FIG. 5/7 depicts the invention using small rectangle L,E,D,S (LIGHT EMMITING DIODS) to display the time as a watch.

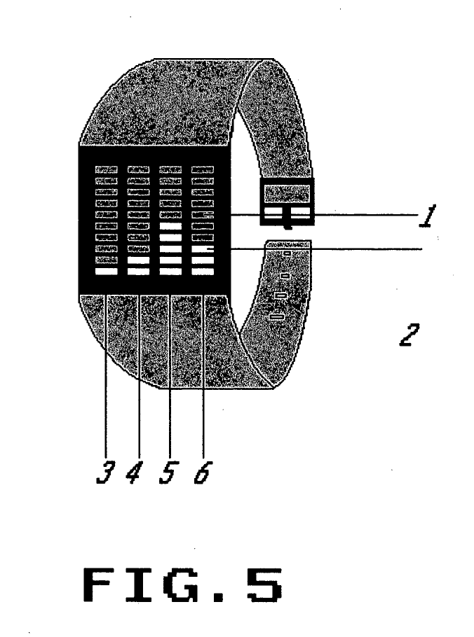

FIG. 6/7 depicts the invention using small round L,E,D,S (LIGHT EMMITING DIODS) to display the time as a watch.

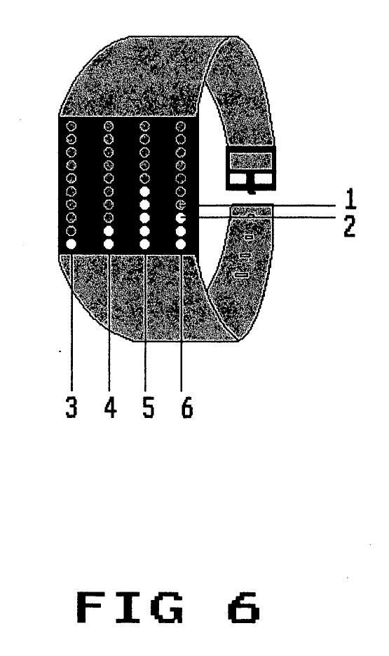

FIG. 7/7 depicts the clock face of the invention as it would appear as a L,C,D, (LIQED. CHRISTAL DISPLAY) displaying the inverted clock face of the invention, this would be used to project the clock face of the invention with a projector. The drawing depicts the object larger than it actually is.

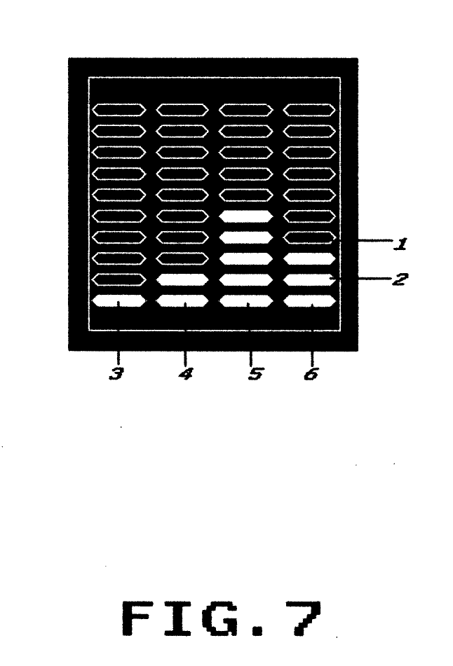

### DETAILED DESCRIPTION OF THE INVENTION

The new clock or watch that I have invented is a new and original digital time keeping system and its new and original time display system. The time is displayed in four vertical rows of ten units, each of the four vertical rows of ten units (reference numbers, 3, 4, 5, 6,) individually represents a number according to how many of the units are displayed, or that are showing. Reference number 1 is a unit that is not showing, or that is not displaying and that you do not count, and reference number 2 is a unit that is showing (or displaying) and that you do count, so when you count the units that are showing (or displaying) in each of the four vertical rows of ten units from left to right, the four numbers give you the time.

The new clock or watch can use different display systems to display the units that are showing and the units that are not showing, in drawings 1/7, 4/7, And 7/7 the new clock or watch is depicted using a liquid crystal display system To depict the units that are showing (reference number 2) and that are not showing (reference number 1). When the new clock or watch is using a liquid Crystal display system, the shape of the units can vary, using any shape, letter Number, or even company logos. In the case of drawings, 2/7, 3/7, 5/7, 6/7, The display system is based on light emitting diodes, Reference number 1, of Drawings 2/7, 3/7, 5/7, 6/7, depicts a light emitting diode that is not lit, witch Depicts a unit that is not showing (or displaying) and reference number 2 of Drawings 2/7, 3/7, 5/7, 6/7, depicts a light emitting diode that is lit witch depicts A unit that is showing (or displaying).

Mass production of the new clock or watch is simple, a digital quarts time keeping processor keeps the time and displays the time by switching on and of The units that display the time in the four vertical rows of ten units, giving you the four numbers that give you the time, in all of the drawings the time displayed is twelve fifty three, as the first of the four vertical rows of ten units Is displaying one unit (meaning the number one) the second row of ten units is displaying two units (meaning the number two) the third vertical row of ten units Is displaying five units (meaning the number five) and the fourth and last row of ten units is displaying three units (meaning the number three) so when you count the units that are showing in each of the four vertical rows of ten units from left to right the numbers display the time (12.53).

1. What I claim as my invention is a new clock—watch, both the display system and the digital electrical system that controls the display system to display the time. The new clock or watch that I have invented displays the time in four vertical rows of ten units, each of the four vertical rows of ten units individually represents a number according to how many of the units are showing (or displaying) so when you count the units that are showing (or displaying) in each of the four vertical rows of ten units from left to right the four numbers give you the time. A digital quarts time keeping system keeps the time and the rest of the electric system switches on and of the units that display the time creating a new clock—watch.
